(19) United States
(12) Patent Application Publication
(10) Pub. No.: US 2013/0046594 A1
(43) Pub. Date: Feb. 21, 2013

(54) Interactive advertising displays

(71) Applicant: Terrance W. Davidson, Atlanta, GA (US)

(72) Inventor: Terrance W. Davidson, Atlanta, GA (US)

(73) Assignee: Box Office Live Television, LLC, Atlanta, GA (US)

(21) Appl. No.: 13/507,096

(22) Filed: Jun. 4, 2012

Related U.S. Application Data
(60) Provisional application No. 61/520,118, filed on Jun. 4, 2011.

(51) Int. Cl. G06Q 30/02

(52) U.S. Cl. 705/14.4

(57) ABSTRACT

This invention provides one or more motion picture projections in parallel onto showroom window glass; a consumer's touch on at least one portion of the projected image activates a signal from a touch-sensitive film on the same or opposite side of the surface, such that the display initiates an electronic handshake between the screen and the viewer, wherein the handshake comprises a text code or QR code and optionally can be individualized to the particular time, location or consumer. The information transferred through the display to the consumer then enables the consumer to make a purchase under secure conditions through a remote transactional interface, for instance a purchase of products, services, attendance rights for an event, discount coupons, etc., and or to download related copyrighted material or other data, such as for performances, software application subscriptions, general information and the like.

### RELATED APPLICATION

This application claims priority from U.S. Provisional Patent Application No. 61/520,118 filed Jun. 4, 2011 and entitled “Interactive Advertising Displays,” and incorporates by reference the content of that application in its entirety.

### FIELD OF THE INVENTION

This invention concerns configurations for interactive advertising displays.

### BACKGROUND

For many consumers access to data and purchasing online has made traditional advertisements seem boring and inefficient. Thus the media for static ads is rapidly becoming obsolete. Numerous paper-based magazines and newspapers have folded their operations due to a combination of falling readership and falling demand for ads. Similarly in certain parts of the United States outdoor billboards with static images increasingly are blank, retired or soliciting for advertisers to rent them. Retail stores have also experienced revenue shortfalls because consumer purchases are increasingly made online. Many marketers have expected that the retail malls would be more resilient because there consumers can inspect and compare competing products hands-on in the midst of a smorgasbord of offerings. Nevertheless even mall stores are finding that foot traffic increasingly passes them by unless they introduce video displays or video-like signage.

Video displays for brick-and-mortar stores are not new. It has long been common for television and movie retailers to place a TV or DVD player in showroom windows with a show or movie running, or to place dozens of TVs or DVD players along a large wall that is highly visible throughout the store, and to have all of those appliances playing simultaneously to attract attention to the display. Video ads were also common for a few other types of brick-and-mortar sites, such as with movie trailers at theaters or how-to videos at home improvement stores. Yet until recent years most other types of products or services were not the subject of such ads.

Attracting consumer interest offline is even more difficult for goods and services that are seldom sold in retail stores. Organizers of live events such as theatricals, musical concerts, sports events, comedy shows, special engagements, visiting speakers, political rallies, night clubs, itinerant carnivals and circuses, amusement parks, and so forth have long relied on billboards, TV and radio ads, word of mouth, subscriptions, and most recently web sites specializing in event ticket sales. Except for the TV ads and web sites, the visual component for each of these ads is generally static if present at all. Even when action videos are used, such as in so-called Flash Media on web pages, the ads are placed only in venues that the targeted consumers typically must seek out themselves (such as ticket web sites or sports channels), as opposed to reaching foot traffic in other promising shopping environments. Thus the promoters must use primarily low-touch advertising to boost attendance at events that are high-touch venues. Consequently the marketing approach has been necessarily incongruous with the type of benefit that consumers seek.

Thus, there is an ongoing need for advertising configurations that improve the immediacy, efficiency and experiential gratification that consumers desire when discovering and registering for new special events.

### BRIEF SUMMARY OF THE INVENTION

This invention provides a new configuration that couples use of motion picture advertising videos with immediate remote purchase arrangements through an interactive activation mechanism and an electronic handshake.

In a particular embodiment, the invention is an interactive advertising display system comprising:
a) a projected graphic display comprising at least one interactive element;
b) a messaging module that is activated when one or more interactive elements of the projected display receives an external stimulus;
c) an electronic handshake that is transmitted from the messaging module to a consumer device upon activation of the messaging module wherein the handshake includes information related to a prospective purchase transaction; and
d) a transactional interface that collects purchasing data and implements a transactional exchange in response to a request transmitted by the consumer device wherein the request comprises information from the electronic handshake.

In another embodiment the invention is an interactive advertising display system comprising:
a) a projected graphic display on an electronic display screen comprising at least one interactive element;
b) a messaging module that is activated when one or more interactive elements of the projected display receives an external stimulus;
c) an electronic handshake upon activation of the messaging module wherein the handshake includes information related to a prospective purchase transaction; and
d) a transactional interface that collects purchasing data and implements a transactional exchange in response to a request transmitted by the consumer device wherein the request comprises information from the electronic handshake.

In an additional embodiment the invention is an interactive advertising display system comprising:
a) a static graphic display on paper media comprising at least one interactive element;
b) a messaging module that is activated when one or more interactive elements of the projected display receive an external stimulus;
c) an electronic handshake that is transmitted from the messaging module to a consumer device upon activation of the messaging module wherein the handshake includes information related to a prospective purchase transaction; and
d) a transactional interface that collects purchasing data and implements a transactional exchange in response to a request transmitted by the consumer device wherein the request comprises information from the electronic handshake.

In a particular embodiment, the transactional request pertains to the acquisition of the acquisition of attendance rights for an event. In an alternative embodiment, the transactional request pertains to the acquisition of copyrighted material. In a further embodiment, the transactional request pertains to a purchase order or other fund transfer.

In one embodiment, the invention provides one or more motion picture projections in parallel onto showroom window glass. In this embodiment a consumer's touch upon or electronic transmission to at least one portion of the projected image activates a signal from a touch-sensitive film on the same or opposite side of the surface, such that a messaging module in electronic communication with the display initiates an electronic handshake between the screen and the viewer, wherein the handshake comprises at least one of a text code or a Quick Response (QR) code. In a different embodiment, the handshake comprises a Near Field Communication (NFC). In a particular embodiment, the handshake optionally can be individualized to the particular time, location and consumer. The information transferred through the display to the consumer by means of the electronic handshake enables the consumer to register for and or buy attendance rights at an event securely and electronically, or to download copyrighted material or other data, such as for performances, software application subscriptions, general information and the like. In various embodiments the purchase is charged to an account for a credit card, debit card, charge card, phone service plan, computer service plan, entertainment media purchase plan or other payment account.

### BRIEF DESCRIPTION OF THE DRAWINGS

FIG. 1 provides non-limiting illustrative caricatures of examples of QR code designs having six different respective amounts of maximum data capacity.

FIG. 2 provides a non-limiting illustrative caricature of an embodiment for a system according to the invention.

### DETAILED DESCRIPTION OF THE INVENTION

The instant invention combines and adapts several elements to address consumer needs that have long been felt but remained unmet. The following definitions are intended to clarify the scope of terms used in the subsequent text describing the invention.

### DEFINITIONS

The term “interactive” refers to use of a display medium that advertises a product, service or event and permits a user to provide a stimulus or data input in response to which the display medium provides additional information or selection choices for acquiring that product, service or event.

The terms “advertising” and “advertisement” have their usual and customary meaning in the marketing arts.

The term “advertising display” refers to an advertisement comprising at least one of visual, audio, and or tactile elements.

The term “interactive advertising display” refers to an advertisement that provides additional information in an automated response to a consumer's presence, proactive contact or selection of a preference.

The term “electronic display screen” means a screen for the display of video images such as a television screen, computer monitor screen, electronic billboard, or other electronic display screen. The term includes but is not limited to display screens based on cathode ray tubes, light emitting diodes, liquid crystal displays, and other electronic display technologies.

The term “flat panel” as used with respect to display screens refers to electronic display screens whose surface for viewing lies essentially along a geometric plane. Illustrative but nonexclusive examples include flat panel display screens for televisions and computer monitors.

The term “touch screen” refers to a display screen on which viewer instructions and choices may be provided by means of touching the screen at particular locations. Likewise a flat panel touch screen is a flat panel screen that has touch-based capabilities for receiving viewer instructions and choices.

The term “paper media” refers to media derived from paper or paper products, and includes but is not limited to paper, poster board, card stock, corrugated cardboard and other sheet products from the paper industry. The term “static” with respect to a graphic display on paper media refers to a condition in which images are fixed, for instance having been printed, glued or otherwise affixed on paper media.

The term “front surface” when used with respect to projection of a display onto a surface refers to a panel on which the image is projected, and specifically refers to the side of the panel that is facing a person viewing the projected image. The term “rear surface” in the same context refers to the opposite side of such a panel.

The terms “transparent” and “translucent” have their usual and ordinary meanings in the arts of window materials.

The term “coated with a light receiving material” when referring to a surface on which an image is projected means that the surface is characterized by a coating, thin film, laminate or other layer that enhances the visibility and or clarity of display images that are optically projected onto that surface.

The term “touch-sensitive film” refers to a film that generates a signal in a circuit when the film is touched for instance by a person. The film's touch-sensitivity may be achieved by any means of detection suitable for the purpose, including sensitivity to pressure applied by a finger or hand, sensitivity to the biologically-generated warmth of a finger or hand, sensitivity to effects introduced into an applied electromagnetic field by a finger or hand placed in its proximity, or other types of sensitivity.

The terms “same side” and “opposite side” with respect to a viewer viewing a display on a surface refer to whether the surface recited is on the same side as the viewer, or is on the opposite side of the display from the viewer.

The term “motion sensor” has its usual and ordinary meaning.

The terms “wall” and “showroom window” have their usual and ordinary meaning in retail environments.

The term “consumer” as used herein refers to an actual or prospective purchaser of advertised goods.

The terms “purchase” and “transaction” have their ordinary meaning in the retail arts, and include the scope of their meaning for transactions online and by other telecommunication media.

The term “interactive element” as used herein with respect to an advertising display refers to a feature that generates an electronic signal communicating a consumer's presence, interest or preferences, and whereby the signal is generated in response to detected motion, tactile pressure, heat from a finger or hand, electromagnetic distortion caused by a finger or hand in an electromagnetic field, or other detected phenomena. The detection is by automated means and may be mechanical, electronic, electrochemical, optical, or other automated means. The interactive element is further characterized in that the signal communicating the presence, interest or selection serves as an automated prompt causing the display to provide additional information or selection choices to the consumer.

The term “graphic” as used herein with respect to a display refers to the display of visual images. As used herein the images may include but are not limited to text, drawings, photographs, abstract art, color motifs, and holographs. The term graphic includes but is not limited to videos such as animated cartoons, motion photography, stereographic “3D” sequences, and other dynamic visual media.

The term “projected graphic display” refers to a graphic display that is projected onto a surface. Illustrative surfaces include the surfaces of walls, showroom windows, flat panel displays, and flat panel screens but the invention is not so limited. In particular embodiments, the display is projected onto a coated or uncoated rear surface of a transparent or translucent material. In some embodiments, the display is projected onto wall or showroom window located in a retail establishment. In certain embodiments the wall or showroom window is located in a pedestrian venue such as in an airport hallway or a highway rest stop foyer. In further embodiments the display may be projected onto a flat panel touch screen or another flat panel screen.

The term “video” refers to a graphic narrative or other graphic sequence such as a motion picture or animated feature. In certain embodiments, the term video refers to an audiovisual work. In certain embodiments the term video include multisensory media that include not only a video display but also one or more sensory stimuli for tactile, olfactory and/or taste experiences.

The term “video display” refers to a display such as an advertising display having a video feature.

The term “messaging” as used herein refers to the provision of data or a text message by electronic means. In certain embodiments, messaging is conducted by means of wireless electronic or photonic transmissions. In particular embodiments messaging is conducted by the transmission of digital signals; in certain other embodiments messaging is conducted by the transmission of analog signals. The term text message includes the transmission of numerical digits, alphabetic characters, and foreign language pictograms, depending only on the sender's or recipient's preferences and choice of characters.

The term “messaging module” refers to a system component that has a dedicated purpose of messaging in response to a consumer's prompt at an interactive element of a display. Persons of ordinary skill in the art of telecommunications are familiar with a variety of configurations for circuits and subcircuits that can serve this function; each of these configurations is contemplated respectively for use in messaging modules within the scope of the invention. Messaging according to the invention is by a wireless means such as a radiofrequency signal, infrared signal, ultrasonic or other signal, or other wireless means.

The term “activate” as used herein with respect to a messaging module refers to providing an electronic, photonic, electromagnetic, voice or other sound, or other input signal that prompts the module to transmit a programmed responsive message.

The terms “prospective transaction” and “prospective purchase transaction” refer to a consumer transaction for which a messaging module has been activated by means of an interactive element in an interactive advertising display, but for which the respective purchase by the consumer has not yet been completed.

The term “external stimulus” as used herein with respect to an interactive advertising display refers to detection of a consumer's presence, interest or selection by an interactive element. In some embodiments, the means of detection requires a tactile or vibrational input. In other embodiments, the means of detection receives an electronic signal from a consumer device. In alternative embodiments, the means of detection detects a manually induced distortion in an otherwise static electromagnetic field, wherein the distortion arises from a hand or finger placed at a particular point in the display. In still other embodiments, the means comprises a voice command.

The term “electronic” has its normal and customary meaning in the electronic arts.

The term “electronic handshake” refers to the transfer of a body of data sufficient to describe, authorize and/or initiate a desired transaction by a consumer, in which the body of data is transferred from a messaging module to a consumer electronic device. In a particular embodiment of the invention, an electronic handshake is an analog or digital wireless telecommunication of information from an interactive advertising display to a consumer device. In some embodiments the messaging is provided in the form of a bar code, QR code, text code, phone number, texting number, URL code, or other code. Optionally the electronic handshake may entail two-way communication between the messaging module and consumer device, conveying serial iterations of data and/or inquiries about the prospective transaction to customize it to a consumer's tastes.

The term “consumer device” refers to a device capable of wireless telecommunication and may be, but is not limited to, a phone (such as a cell phone, vehicle phone or satellite phone), computer (e.g., a desktop computer, laptop computer, tablet computer, palmtop computer, or other portable computer), messaging device such as a pager or BlackBerry®, personal digital assistant, entertainment media player, portable electronic game device, device for reading electronic books, or other consumer device to the extent that it is capable of wireless telecommunication.

The term “transactional interface” refers to an exchange system, whether in hardware, software protocols or manual entry, that processes purchase orders or consumer acquisition codes that are conveyed by means of electronic communications and in a particular embodiment by means of wireless telephonic communications. Examples of transactional interfaces include automated online order-taking and order-filling services such as for purchases over the Internet initiated by wireless devices, but in some embodiments may include a combination of human and electronic tasks on a seller's side of the transaction such as in a call center.

The term “electronic interface under the control of an algorithm” refers to a pre-programmed electronic device. When used in reference to automated processing of purchases it refers to use for that purpose.

The term “call center” has its usual and ordinary meaning in the retail arts.

The term “code-generating program” refers to a program that generates a code, e.g., for validation and authorization purposes for purchases to be made by a follow-on step to take place in a secure digital environment.

The term “collect” with respect to receipt of purchasing data by a transactional interface refers to either passive receipt of wirelessly transmitted data or active solicitation of data in a wireless two-way communication sequence with a consumer device.

The term “purchasing data” with respect to data collected by a transactional interface refers to: data identifying the product, service or rights being acquired by a consumer in a respective transaction; any promotional code or discount code required for price adjustment; account numbers and authorization codes required for the consumer to release payment for the purchase to the seller; and optionally marketing information concerning the buyer's location, retail affiliation if at a branded display site, date and/or time of day when the electronic handshake was initiated, date and/or time of day at which the consumer initiated contact with the transactional interface, a listing of other items shown on the interactive display system at or from which the consumer received the electronic handshake, a count of total number of transactions completed within a given period by customers who received and electronic handshake from the same interactive display system, a statement of total aggregate dollar value of transactions completed within a given period by consumers who received an electronic handshake from the same interactive display system, and/or other marketing information.

The term “request” as used herein with respect to a consumer's initiation of a purchase transaction through contact with a transactional interface refers to the consumer's inquiry or instruction regarding choices for that particular purchase, In particular embodiments the request includes the provision of one or more types of purchasing data that were received from the messaging module by the consumer device as part of the electronic handshake. In various embodiments the request may further comprise a purchase order, a donation, a bid, a fund transfer, or an authorization to bill the transaction to an account. In particular embodiments an account transfer may be authorized from a credit card, debit card, charge card, bank account, phone service account such as for a cell phone or land line, iTunes® account, online game account, other account for computer services, or other subscriber account.

The term “implements a transactional exchange” as used with respect to the action of a transactional interface means the execution of a transaction in accordance with the consumer's identification of goods, services or rights, and in accordance with the consumer's express or explicit consent to price terms and payment terms.

The term “QR code” refers to the eponymous QR code (short for Quick Response) of commerce, a two-dimensional matrix bar code readable by e.g., QR barcode readers and camera phones. The code consists of black modules arranged in a square pattern on a white background. The information encoded can be text, uniform resource locators (URLs) or other data.

The term “text code” includes, but is not limited to, Short Message Service (SMS) text, the communication service component of phone, web and mobile communication systems that employs standardized communications protocols to exchange short text messages between fixed line and or mobile phone devices. SMS text messaging is ubiquitous in North America, Europe, Asia and Australia. The term SMS as used herein is synonymous with all types of short text messaging as well as the user activity itself.

The term “near-field communication” (NFC) refers to a set of short-range point-to-point wireless technologies, typically operating over a distance of 4 cm or less with a set-up time of less than 0.1 second, but may operate over a range of up to 20 cm. Typical current NFC devices operate at the globally available and unlicensed 13.56 MHz radio frequency(RF) ISM band and at data transfer rates of 106, 212, 424 or 848 kbit/s, and require <15 mA power in their reading mode. Most of the RF energy is concentrated in the allowed 14 kHz bandwidth range, but the full spectral envelope may be as wide as 1.8 MHz when using ASK modulation.

The term “Bluetooth” has its typical meaning in communications, and refers to a standardized communications protocol that operates over WPAN networks, follows IEEE 802.15.1 standards, operates over a range of about 10 m at 2.5-2.5 GHz, currently with a 1.0 to 2.1 Mbit/s data transfer rate and set-up times of up to 6 seconds.

The term “copyrighted material” includes but is not limited to material that is the subject of entertainment copyrights, such as: hardy copy or electronic books; movies; audio and video recordings of musical performances, comedy shows, lectures, or other entertainment; event posters; and the like.

The term “attendance rights” refers to a person's privilege to attend or otherwise be represented at an event or venue for which attendance is limited by a host, sponsor, organizer or other entity or for which consent from a host, sponsor, organizer or other entity is otherwise required for admittance. As the term is used herein a person's “attendance rights” may optionally be documentable by a key, pass, ticket, pass code, invitation, invitation list, identification card, stamped approval, temporary or permanent tattoo, or other evidence in physical or electronic form.

The terms “purchase order,” “option to purchase”, “bid at auction,” “donation,” and “discount coupon” have their usual and ordinary meanings.

The “consideration” when used with respect to transactions has its usual and ordinary meaning in contract law.

The term “account” when used with respect to payment for purchases means an account to which payment may be charged and/or from which payment may be received, and has its usual and ordinary meaning in the payment processing arts.

### DESCRIPTION

Consumers have an increasing need for constant communication and speedy transactions. A contemporary sophisticated consumer usually carries at least one device for electronic communications and often several. Conventional camera-equipped cell phones are particularly common, but Apple i-Pods™, BlackBerry™ messaging devices, tablet computers, and the like are also ubiquitous. Typically, one or more of these devices is the consumer's preferred choice for researching product benefits and competitive pricing before purchase and for actually conducting purchase transactions. Thus, a cell phone or other mobile device represents the actual preferred point of purchase for a host of consumers. Moreover, the wide availability of high-quality video entertainment has made consumers increasingly sophisticated and discriminating regarding retail displays.

Yet, despite preferences for using electronic media, consumers continue to feel energized by the experience of shopping at malls in person, where they can inspect and compare the latest wares on display in a smorgasbord of retail venues while being near to many other like-minded shoppers. Because consumers are now much more discriminating about retail displays, and because they now manifest electronic connectedness at all times, they have come to expect sophisticated and electronically savvy displays even at stores that sell traditional goods.

To date, attempts at automated interactive advertising displays have made little if any accommodation for these preferred modes of consumer interaction. Clapper in U.S. Pat. App. Pub. No. 2002-0069405 (now U.S. Pat. No. 7,325,245) discloses selectable television advertisement segments, each corresponding to one of a plurality of selectable zones on the TV screen; whereby in response to selection of a particular zone by a viewer, the corresponding selectable video advertisement segment is delivered directly to that viewer to facilitate ordering of products or services, and to pay a spokesperson in a manner that corresponds statistically to ad segment selection and delivery. U.S. Pat. No. 7,325,245 to Clapper, assigned to Intel, discloses use of encoded URLs or other types of links in video frames to enable searches pertaining to video information selected from storage media. In U.S. Pat. Pub. No. 2008-0295129 Laut discloses selectable advertising in video commercials, particularly in the context of the Internet. In U.S. Pat. App. Pub. No. 2003-0078840 (now U.S. Pat. No. 6,708,176 assigned to Bank of America Corporation) Strunk et al. disclose use of a remote identification sensing device comprising a transceiver configured to communicate with a transponder (the transponder being individually coded for and carried by a consumer, for instance in a credit card, ATM card or key fob issued to its owner by a bank) by use of electromagnetic transmission signals without direct physical contact to generate at least one interactive poster on a group display device such as a large television or glass display technology.

The present invention moves well beyond those paradigms by providing a seamless integration of the display technology with remote instant purchase. The invention provides a system comprising a video display having interactive elements, a messaging module, an electronic handshake between the display and a consumer device, and a transactional interface.

In a particular embodiment, the video display is provided on window glass or specialty screen materials by means of rear projection. Illustrative and non-limiting suitable rear projection films for window glass are provided for instance by 3M (Vikuiti™ rear projection film is a flexible, self-adhesive, easily custom-cut film based on microbead technology that can be applied to windows or transparent partitions, and if so desired is fast and easy to remove, and can be integrated with other window graphics). Typically, glass windows are also coated with an anti-reflective film on the viewing side. An illustrative, non-limiting example of films suitable for this purpose is 3M's Vikuiti™ ARMR-200 (5 mil polyester substrate with, removable, optically clear pressure sensitive adhesive). See, e.g., http://solutions.3m.com/wps/portal/3M/en_USNikuiti1/BrandProducts/main/productliterature/frontsurfacefilms/. Specialty rear-lit screens are offered in rigid or flexible form, for instance from Da-Lite (e.g., product no. DA-50WA Wide Angle Polacoat rear projection screen, at http://www.da-lite.com/products/selecting.php?viewMode=rear) and Luminvision (see e.g., http://www.luminvision.in/pro-01-ps.html).

In a particular embodiment, the video displays of the invention are further comprised of a transparent, thin touch-sensitive film. The touch-sensitive film may be adhered on the viewing side of a pane for direct sensitivity to pressure, or on the reverse side if the film's sensitivity to small electrical fields is leveraged. Non-limiting illustrative examples of such films include offerings from Displax (based in Portugal, with a 100-micron-thick film and a nanowire grid is licensed from another company such as Visual Planet), Oga, Inc. (0.5 mm thick product with conductive rubber affixed to poly(ethylene terephthalamide, capable of detecting force in three directions on a flat film), Eagle Touch Technologies Co. Ltd. (of Hong Kong, offering a 5-wire USB touch screen film), and Shanghai Kunyi Industrial Co., Ltd. (of Shanghai, China, offering USB touch screen films for LCDs). Alternatively, a thick product may be used such as Microsoft's Surface, which is 23 inches thick, however that thickness is more useful for modeling the shape of a hand than for simple and efficient contact with a touch-sensitive video.

Touch-sensitive screens can be quite robust. For instance, specifications for the Eagle Touch product include a 3 H surface hardness, 80% optical clarity, use range from −10° C. to 60° C., storage temperatures of −20° C. to ˜70° C., ability to endure 10 millions strikes, 5V DC operating voltage, 5-25 mA operating current, 30Ω˜300Ω resistance, isolation resistance of 20 MΩ at 25V DC, anti-glare coating, ability to endure operating pressures of 15 g to 70 g, message noise of 5 to 15 milliseconds, and so forth.

In one embodiment, the video-based advertisement is a motion picture with one or more panels depicting persons or logons for respective upcoming events. Upon a prospective customer's initiation of touch contact with a panel, a particular video selection is selected, for example, the selection may be a representative looped video of a particular performer in concert, and or the advertisement is prompted to display data or prompt the user for contact information to which data will be sent. In some embodiments, the visitor may separately request to see a mini-video from the event. In some embodiments, the visitor may separately elect to receive data for use for a corresponding purchase transaction or information request. In some embodiments, the data that is provided to the consumer upon request may include an event name, performer name, dates, times, locations, price points, purchase code, phone number, payment means and or URL to sign up for the event. In certain embodiments, the data may include the name of a copyrighted work, use terms, price points, purchase code, phone number, payment means and or URL to download copyrighted material such as a song, album, ebook, video, PDF, news, blog, digital magazine, social media, or software applications. In certain embodiments, downloadable copyrighted material is related to live events shown in the interactive video display.

In systems according to the invention, in one embodiment, the data is provided from the interactive display to a consumer or consumer device in the form of a text message by means of a messaging module. In another embodiment the data is alternatively provided to a consumer or consumer device in the form of a QR code by means of a messaging module. In systems according to the invention, in a different embodiment the data is alternatively provided to a consumer or consumer device in the form of a near-field communication by means of a messaging module.

Systems according to the invention further comprise an interface for purchasing or information procurement in which data received by the consumer from the interactive advertisement serves as an electronic handshake to engage the interface. In respective embodiments the transactional interface allows a consumer to purchase attendance rights or copyrightable material by means of a text message, QR code or near-field communication received from the interactive display. In some embodiments the text, QR code or near-field communication is identical to that received from the messaging module of the interactive display and is part of a more complete communication from the consumer to the transactional interface. In other embodiments, the text, QR code or near-field communication from the consumer to the transactional interface is derived from but not identical to data received from the messaging module of the interactive display. In still other embodiments, the communication from the consumer to the transactional interface is informed by but is neither identical to nor derived from data received from the messaging module of the interactive display.

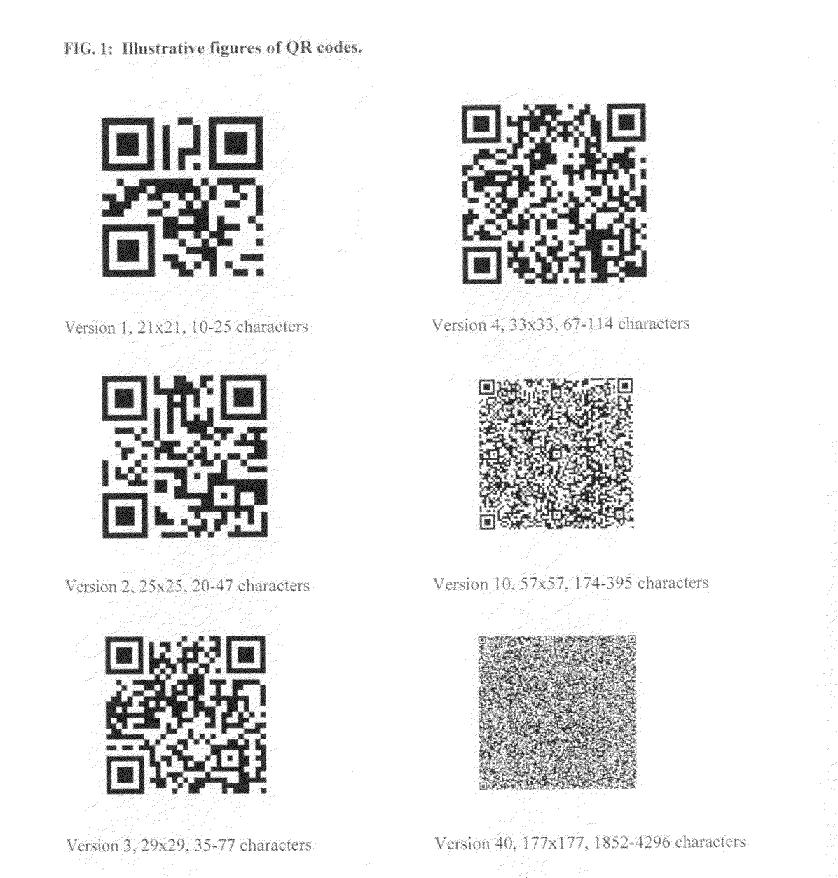

Regarding QR codes, the technology is common in Japan and South Korea and is beginning to find wide use in the United States, for inventory and for retail products. Typically, the functional elements of the code include version information, format information, keys for data and error connection, positioning elements, alignment elements, and timing elements; FIG. 1 of the drawings provides non-limiting illustrative caricatures of QR codes having different capacities for information storage. Cell phone operating systems that accommodate QR codes include Google's Android system, Nokia's Symbian system, the Maemo system, and free applications for the Apple iOS system. Standards for QR coding include those of the AIM (Association for Automatic Identification and Mobility) International (1997), JIS X 0510 (1999), and ISO/IEC 18004:2006 (2006). The use of QR codes is free of any license at the time of this writing. The QR code is defined and published as an ISO standard. Denso Wave owns the patent rights on QR codes, but has chosen not to exercise them and registered the trademark to the term “QR code”. The current maximum capacity for QR codes is 7,089 characters for purely numeric codes, 4,296 characters for alphanumeric codes, 2,953 characters for binary codes, and 1,817 characters for Kanji or Kana codes. Variants of QR codes exist, such as micro QR codes, and their use is likewise contemplated within the scope of the present invention. QR codes have been used in static ads, but not to my knowledge in interactive ads. Demetria Wideman, concessions marketing manager, is said to have launched a QR Code campaign at Hartsfield-Jackson Atlanta International Airport in an industry first, giving passengers special offers and discounts redeemable by mobile phone at participating locations.

Regarding NFC applications, currently NFC always involves an initiator and a target; the initiator actively generates a radio frequency field that can power the target; in many but not all embodiments, the target is passive (i.e., does not have its own power-generating component). Passive designs enables NFC targets to take very simple form factors such as tags, stickers, key fobs, or cards that do not require batteries. An example of a suitable passive target is one containing an inductor coil that becomes charged and converts the passive device to a short-range transponder in the presence of an initiator's weak emitted electromagnetic field. This is like proximity card technology in which NFC is mediated by magnetic induction between two loop antennas located within each other's near field, effectively forming an air-core transformer. NFC peer-to-peer communication is possible where the initiator and target each has its own respective power supply. In the peer-to-peer case, the target is described as active; typically, the initiator and or target device in the peer-to-peer arrangement deactivates its own radio frequency (RF) field while it is waiting for data from the other. Typically, NFC devices can both receive and transmit data simultaneously. Thus, they need to check the radio frequency field and can detect a collision if the received signal matches the transmitted signal's modulated frequency band. Currently, NFC devices exist in one of three configurations: in reader/writer configurations, a NFC device is active and reads a passive tag, as for RFID; in a P2P configuration two NFC devices exchange data; in a card emulation configuration an NFC device behaves like an existing contactless card and can be used with existing technology infrastructures.

Regarding text messaging, SMS for modern handsets evolved from radio telegraphy in radio memo pagers with standardized phone protocols, then became part of the Global System for Mobile Communications (GSM) series of mobile handset standards in 1985 for sending messages of up to 160 characters, and now includes other mobile technologies including ANSI CDMA networks, Digital AMPS, satellite and landline networks including 3G networks and the like. Most SMS messages are mobile-to-mobile text messages though the standard supports other types of broadcast messaging as well. Some notable non-limited examples of text messaging alternative protocols to SMS that are included in the term “text code” as defined herein, include protocols such as SMTP over TCP/IP used by RIM's BlackBerry® devices, as well J-Phone's SkyMail™ and NTT Docomo's Short Mail™.

In certain embodiments, when a handshake occurs between an interactive advertisement and a consumer device comprising a cell phone, a monetary transaction for attendance rights or copyrighted material is performed automatically and charged to the owner of the consumer device by means of a bill for the associated cell phone or by means of a credit card account, debit card account, charge card account, or Apple's wave technology.

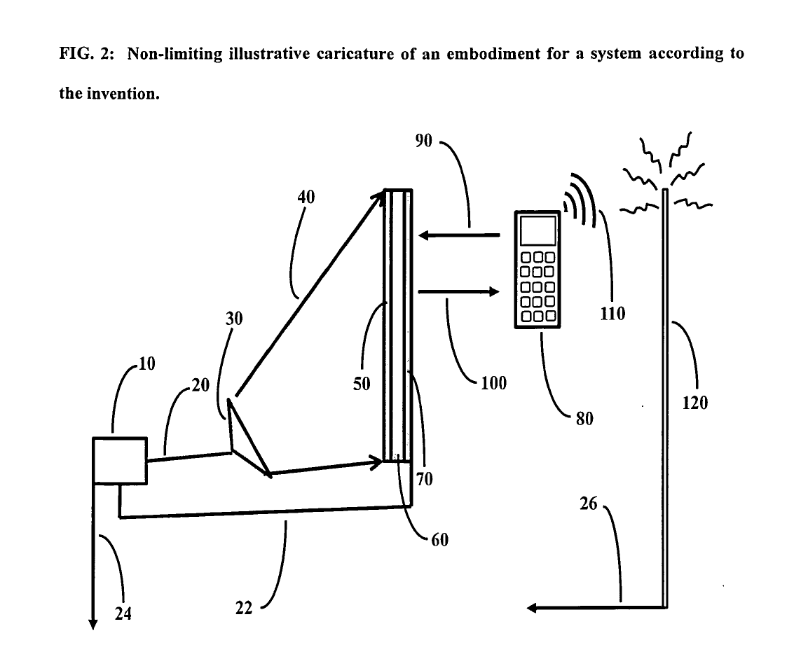

Referring now to the schematic caricature in FIG. 2, systems according to the invention may be understood by non-limiting illustrative embodiments. In one such embodiment, the invention is a system providing a computer server (10) that is in electronic communication with a video projector (30) by means of a first transmission line (20) that optionally may be wireless, and optionally in electronic communication with a touch-sensitive film (70) by means of a second transmission line (22) that optionally may be wireless, and optionally in electronic communication with one or more other electronic devices for transactional purposes by means of a third transition line (24) that optionally may be wireless. In a particular embodiment, the system further comprises graphic projections (whose upper edge is indicated by 40) from the projector (30) to provide a plurality of stationary or moving images in parallel onto showroom window glass (60), optionally onto a rear-lit film (50) on the glass (60).

In a particular embodiment a consumer provides an input (90) by either physical touch or electronic communication in either case targeting at least one portion of the projected image, thereby activating an electronic signal (100) from a touch-sensitive film (70) located on the same or opposite surface of the glass. The touch-sensitive film is in electronic communication with the same server (10) or another server, in either case by means of the second transmission line (22) that optionally may be wireless, and in either case the server in electronic communication with the touch-sensitive film prompts a signal from the touch-sensitive film by means of a messaging module.

The signal (100) comprises an electronic handshake transmitted from the interactive display to a consumer device (80) and comprising transaction details in the form of a text code or QR code, and optionally can be individualized to the particular time, location and or consumer. At the consumer's option the consumer device (80) wirelessly and or by landline transmits a signal (110) to a receiver (120) that is in electronic communication by means of a fourth optionally wireless transmission line (26) with the server (10) or optionally another transaction device, in either case thereby completing a transaction. In certain embodiments the consumer device is a cellular telephone or another mobile electronic device such as a tablet computer, a mobile entertainment media device such as an MP3 player, a consumer game device, a personal digital assistant, a texting device, a reading device for electronic books, or an analogous consumer device, to the extent that the device is capable of engaging in telecommunication.

In some additional embodiments the electronic signal (100) is activated by detection of motion by a sensor instead of, in addition to, or as an alternative to activation by stimulation of a touch-sensitive film.

In one embodiment, the charges for the transaction illustrated in FIG. 2 are billed to an account for one of the following: a cell phone, a tablet computer (of which an Apple iPad® computer is a non-limiting example), an entertainment media device (of which an Apple iPod® device is a non-limiting example), a consumer game device, a personal digital assistant, a texting device, a credit card, a debit card, a charge card, or an account for Apple's wave technology. In particular embodiments, the transaction concerns secure electronic acquisition of data, registration, and or purchase of attendance rights for an event, and or download of related copyrighted material or other data. In further embodiments the transaction concerns secure electronic transfer of a discount coupon for an event, goods, or services, and may be a purchase by the buyer or a free transfer of one or more coupons by the seller.

The invention may be better understood by considering the following non-limiting illustrative examples.

### Example 1

The interactive advertising display is 4 feet high, 8 feet wide, and the projection surface is a storefront window with a Vikuiti™ rear projection film on the rear surface and projection of images onto the rear of the window. The display has 8 square images, each one featuring a silent active looped video of a portion of a different musical concert, with the name of the performing group and dates overlaid visually on each respective video in the projection. The display has a Displax™ touch-sensitive film laminated on the front surface of the window. A command line on the projected display says “touch any event video to learn more or buy tickets”. When a consumer touches a respective video square, the video continues playing but pressure from the consumer's hand activates a messaging module, which then causes between 15 seconds and two minutes of audible corresponding sound from that portion of the concert to be piped through an amplifier to the consumer, and which also causes a QR code to be shown for 15 seconds in an image size suitable to be photographed and/or read by a cellular phone from between 1 and 3 feet away.

When the consumer photographs the QR code with a camera on a cell phone, a universal software application on the phone decrypts the code, yielding a phone number or website URL for placing an order, and also provides an event identification code, price per ticket, authorization code, and optionally a discount code, depending on the event. The consumer then calls the destination phone number or visits the website URL wirelessly, enters the event identification code, price per person to attend, authorization code, and optionally discount code, and if more than one ticket is to be purchased enters the number of tickets.

In some embodiments a specific plurality of tickets to be purchased as a block (e.g., 4 tickets in seat sequence) and/or to be located in a particular portion of the event venue (e.g., balcony seats or e.g., center field) may be represented by a distinct touch-sensitive area on the interactive display and have their own identification code, authorization code and or discount code.

Upon receiving the consumer's input a transactional interface that collects data through the telephone call or web page processes the data from the request, records the purchase, reads the cell phone account number from the cell phone's caller identification information, charges the price of admission against the account number for the cell phone, and sends the consumer a new and separate bar code, text code, QR code, other computer-readable code, or other document, which can be used respectively at the event admission gate as a virtual ticket for entry to the event if shown on the screen of the consumer device, or which may be printed if a hard copy ticket must be provided by attendees at the gate.

### Example 2

The interactive advertising display is 5 feet high, 20 feet wide, and the projection surface is a wall of two-inch thick transparent glass with a projection film on the front surface and projection of images from the rear of the window. The display includes 16 circular images, each one featuring a silent still shot of a portion of a different musical concert, with the name of the performing group and dates overlaid visually on each respective video in the projection. The display has a touch-sensitive film laminated on the rear surface of the window. A command line on the projected display says “knock on any photo once to see the group in a live concert, twice to buy the album and three times to do both”. When a consumer's knuckles knock on a respective photo circle once or three times, a sensor of consumer-induced disturbances is activated, counts the knocks and sends a signal activating a three-minute looped audiovisual movie corresponding to the respective photo circle on the display. Overlaid on the video are additional details: date, location, playlist, number of tickets still available at a box office, tour schedule, or other details. When a consumer's knuckles knock on a respective photo circle twice or three times a messaging module, the sensor activates a messaging module, causing a text code, bar code or QR code to be shown for 60 seconds in an image size suitable to be photographed and/or read by a cellular phone from between 2 and 4 feet away, together with the line, “to obtain the album, photograph this code with your cell phone, then decrypt it on your phone and follow the instructions in the message”.

When the consumer photographs the code with a camera on a cell phone, a universal software application on the phone decrypts the code, yielding a phone number or website URL for placing an order, and also provides additional details about the event (program for the event) event identification code, price per copy, authorization code, and optionally a discount code, depending on the event. The consumer then calls the phone number or visits the website URL wirelessly and forwards the text code, bar code or QR code, and if more than one copy is to be purchased enters the number of copies desired.

Upon receiving the consumer's input an electronic transactional interface that collects data through the telephone call or web page processes the data from the request by reading the bar code, QR code or other code originally sent to the consumer, and sends back a message, “choose a form of payment from the menu shown”. The menu includes options for a credit card, debit card, charge card, or cell phone account. Upon the selection of one of those by the consumer the transactional interfaces requests the consumer to select a particular payment means (e.g., Visa, MasterCard, or American Express for a credit card; e.g., Visa, Mastercard, Maestro or other bank for a debit card; e.g., American Express or Diners Club for a charge card; e.g., phone number for a cell phone account or highlighting a “same phone” button. Upon selection of the particular payment means the transactional interface requests a zip code (e.g., for a credit card), PIN (personal identification number) or other identifying information to confirm that the payer is an authorized user of the account. All of these exchanges may be encrypted digitally for enhanced security of the wireless transaction.

Upon the receiving the necessary information the transactional interface logs the purchase information, logs additional marketing information encrypted in the original code provided to the consumer, and downloads to the consumer the requested album.

### Example 3

The interactive advertising display is a television screen that is 4 feet high and 6 feet wide and inset into the wall of a retail establishment. The display includes 4 rectangular images, each one featuring animated trademark images of 2 teams for a different respective sports event, with the names of the teams and dates stated underneath each respective video in the projection, and with the outline of a hand overlaid in red on the center of each image rectangle. A command line on the projected display says “place hand where shown on screen to purchase tickets”. When a consumer's hand is place on an image, a detector activates a messaging module, which provides information on the number and location of seats available, displays a phone number for a box office and causes a text code, bar code or QR code to be shown in an image size suitable to be photographed and/or read by a cellular phone from between six inches and 2 feet away, together with the line, “to obtain tickets, photograph this code with your cell phone, then decrypt it on your phone and follow the instructions in the message”.

The remainder of the transaction proceeds as in Example 1 or 2.

### Example 4

The interactive advertising display is a printed mural poster on paperboard media that is 5 feet high and 10 feet long, with additional images projected onto white space on the poster from above onto its front side. The display includes 5 rectangular images, each one featuring upcoming museum events, with the event names, dates, prices and other details stated above each respective image, and each featuring a solid black circle six inches in diameter at its center. A command line on the projected display says “touch a black circle to purchase tickets for that event”. When a consumer touches the image, a motion detector activates a messaging module, which displays a QR code to be shown in an image size suitable to be photographed and/or read by a cellular phone from between 18 inches and 30 inches away, together with the line, “to obtain tickets, photograph this code with your cell phone, then decrypt it on your phone and follow the instructions in the message”.

The remainder of the transaction proceeds as in Example 1 or 2.

The embodiments of the invention as described herein are merely illustrative and are not exclusive. Numerous additions, variations, derivations, permutations, equivalents, combinations and modifications of the above-described composition and methods will be apparent to persons of ordinary skill in the relevant arts. The invention as described herein contemplates the use of those alternative embodiments without limitation.

I claim:

1) An interactive advertising display system comprising:
a) a projected graphic display comprising at least one interactive element;
b) a messaging module that is activated when one or more interactive elements of the projected display receives an external stimulus;
c) an electronic handshake that is transmitted from the messaging module to a consumer device upon activation of the messaging module wherein the handshake includes information related to a prospective purchase transaction; and
d) a transactional interface that collects purchasing data and implements a transactional exchange in response to a request transmitted by the consumer device wherein the request comprises information from the electronic handshake.

2) An interactive advertising display system according to claim 1 wherein the projected graphic display is displayed on a wall or showroom window.

3) An interactive advertising display system according to claim 1 wherein the graphic display is projected onto a surface that consists essentially of a transparent or translucent material, and the surface onto which the display is projected is a rear surface that is optionally coated with a light-receiving material.

4) An interactive advertising display system according to claim 1 wherein the graphic display is projected onto a surface that optionally consists essentially of a transparent or translucent material, and the surface onto which the display is projected is a front surface that is optionally coated with a light-receiving material.

5) An interactive advertising display system according to claim 1 wherein the interactive elements are selected from the group consisting of: a touch-sensitive film that is located on the same side of the display as a consumer user; a touch-sensitive film that is located on the opposite side of the display from a consumer user; and a motion sensor;

6) An interactive advertising display system according to claim 1 wherein the external stimulus is selected from the group consisting of: motion by a consumer; pressure applied by a consumer's finger or hand; heat emanating from a consumer's finger or hand; or electromagnetic distortion introduced by a consumer's finger or hand.

7) An interactive advertising display system according to claim 1 wherein the messaging module communicates a message comprising visible or audibly described characters selected from the following group: graphic images; alphabet letters; numeric digits; pictographic foreign symbols, or coded images such as a bar code or QR code.

8) An interactive advertising display system according to claim 1 wherein the messaging module when activated communicates to a consumer by means of providing a bar code, a QR cord or a text code.

9) An interactive advertising display system according to claim 1 wherein the consumer device is selected from the group consisting of a cellular telephone, laptop computer, tablet computer, pager, texting device, personal digital assistant, entertainment media player, or portable electronic game device.

10) An interactive advertising display system according to claim 1 wherein the electronic handshake comprises at least one of an authorization code and a promotional code provided by the messaging module for purposes of a follow-on consumer transaction.

11) An interactive advertising display system according to claim 1 wherein the electronic handshake comprises contact information provided graphically or by wireless transmission by the messaging module for purposes of a follow-on consumer transaction.

12) An interactive advertising display system according to claim 1 wherein the transactional interface is selected from the group consisting of: an electronic interface under the control of an algorithm for automated processing of purchases; a call center; and a code-generating program that automatically returns an alphanumeric post-call authorization code digitally in response to receiving and after validating a legitimate pre-call authorization code digitally.

13) An interactive display system according to claim 1 wherein the transactional exchange pertains to a consumer's acquisition of at least one of the following: particular copyrighted material; attendance rights for an event; a product or service; and a discount coupon for a product or service.

14) An interactive display system according to claim 1 wherein the transactional exchange pertains to a fund transfer for at least one of the following: purchase order; acquisition of option to purchase; bid for purchase at auction; and a donation to a not-for-profit organization.

15) An interactive display system according to claim 1 wherein the collected purchasing data comprises:
a) a code for the identity of goods or service to be acquired in the transaction;
b) a consumer account code to be applied for purchase of the goods; and
c) at least one of the following:
i) a location of the interactive display system at or from which the consumer received the electronic handshake;
ii) a retail affiliation of the interactive display system at or from which the consumer received the electronic handshake;
iii) a date and/or time of day at which the consumer received the electronic handshake;
iv) a date and/or time of day at which the consumer initiated contact with the transactional interface;
v) a listing of other items shown on the interactive display system at or from which the consumer received the electronic handshake;
vi) a count of total number of transactions completed within a given period by consumers who received an electronic handshake from the same interactive display system; or
vii) a statement of total aggregate dollar value of transactions completed within a given period by consumers who received an electronic handshake from the same interactive display system.

16) An interactive display system according to claim 1 wherein a consumer's consideration for the transactional exchange is provided in the form of authorization to bill a consumer's account at one off the following: a cell phone account, a computer services account, an entertainment media account, a consumer game account, a pager services account, a personal digital assistant account, a texting services account, a credit card account, a debit card account, or a charge card account.

17) An interactive advertising display system comprising:
a) a projected graphic display on an electronic display screen comprising at least one interactive element;
b) a messaging module that is activated when one or more interactive elements of the projected display receives an external stimulus;
c) an electronic handshake upon activation of the messaging module wherein the handshake includes information related to a prospective purchase transaction; and
d) a transactional interface that collects purchasing data and implements a transactional exchange in response to a request transmitted by the consumer device wherein the request comprises information from the electronic handshake.

18) An interactive advertising display system according to claim 17 wherein the electronic screen is a flat panel touch screen.

19) An interactive advertising display system according to claim 17 wherein the electronic screen is a flat panel monitor screen or flat panel television screen.

20) An interactive advertising display system comprising:
a) a static graphic display on paper media comprising at least one interactive element;
b) a messaging module that is activated when one or more interactive elements of the projected display receive an external stimulus;
c) an electronic handshake that is transmitted from the messaging module to a consumer device upon activation of the messaging module wherein the handshake includes information related to a prospective purchase transaction; and
d) a transactional interface that collects purchasing data and implements a transactional exchange in response to a request transmitted by the consumer device wherein the request comprises information from the electronic handshake.
